(19) United States
(12) Patent Application Publication
(10) Pub. No.: US 2026/0006172 A1
(43) Pub. Date: Jan. 1, 2026

(54) HEAD-MOUNTED DISPLAY, CONTROL METHOD, AND NON-TRANSITORY COMPUTER READABLE STORAGE MEDIUM THEREOF

(71) Applicant: HTC Corporation, Taoyuan City (TW)

(72) Inventor: Chao-Hsiang LAI, Taoyuan City (TW)

(21) Appl. No.: 18/757,461

(22) Filed: Jun. 27, 2024

(51) Int. Cl. H04N 13/398; G06F 3/01; H04N 13/327; H04N 13/366

(52) U.S. Cl. CPC H04N 13/398; G06F 3/014; G06F 3/017; H04N 13/327; H04N 13/366

(57) ABSTRACT

A head-mounted apparatus, control method, and non-transitory computer readable storage medium thereof are provided. The head-mounted display calculates a posture corresponding to a hand based on a real-time image, wherein the posture comprises a reference point located on the hand. In response to determining to activate an input operation based on the reference point and a relative position of a virtual object displayed by the display, the head-mounted display selects a first gesture corresponding to the reference point from a plurality of gestures based on the reference point and a plurality of inertial measurement parameters received from a wearable apparatus. The head-mounted display generates an input event corresponding to the virtual object based on the first gesture and an input target corresponding to the input operation.

### BACKGROUND

### Field of Invention

The present disclosure relates to a head-mounted display, control method, and non-transitory computer readable storage medium thereof. More particularly, the present disclosure relates to a head-mounted display, control method, and non-transitory computer readable storage medium thereof that combine image recognitions and inertial measurement parameters to generate control signals.

### Description of Related Art

In recent years, various technologies related to virtual reality have developed rapidly, and various technologies and applications of head-mounted displays have been proposed one after another.

In the existing technology, when a user wears a head-mounted display, the head-mounted display obtains data (e.g., input text) inputted by the user by detecting tap gestures of the user on a virtual keyboard or receives physical button pressing signals from a wearable apparatus worn by the user to obtain the data.

However, jittering and recognition bias caused by user's hand trembling or image recognition latency will lead to poor user experiences.

Additionally, with the popularity of smart phones, they have gradually become the most commonly used electronic products for people. In the meantime, the typing posture on smart phones has also become a human-computer interaction method that people familiar with.

In view of this, how to provide a more stable input method and reduce the difficulty of operating the head-mounted display according to the user's habit is the goal that the industry strives to work on.

### SUMMARY

An objective of the present disclosure is to provide a head-mounted display. The head-mounted display comprises a display, a communication interface, a camera, and a processor. The communication interface is communicatively connected to a wearable apparatus. The camera is configured to capture a real-time image comprising the wearable apparatus worn on a hand of a user. The processor is coupled to the display, the communication interface, and the camera. The processor calculates a posture corresponding to the hand based on the real-time image, wherein the posture comprises a reference point located on the hand. In response to determining to activate an input operation based on the reference point and a relative position of a virtual object displayed by the display, the processor selects a first gesture corresponding to the reference point from a plurality of gestures based on a plurality of inertial measurement parameters received from the wearable apparatus. The processor generates an input event corresponding to the virtual object based on the first gesture and an input target corresponding to the input operation.

Another objective of the present disclosure is to provide a control method, which is adapted for use in an electronic apparatus. The controlling method comprises following steps: capturing a real-time image comprising the wearable apparatus worn on a hand of a user; calculating a posture corresponding to the hand based on the real-time image, wherein the posture comprises a reference point located on the hand; in response to determining to activate an input operation based on the reference point and a relative position of a virtual object displayed by the display, selecting a first gesture corresponding to the reference point from a plurality of gestures based on a plurality of inertial measurement parameters received from the wearable apparatus; and generating an input event corresponding to the virtual object based on the first gesture and an input target corresponding to the input operation.

A further objective of the present disclosure is to provide a non-transitory computer readable storage medium having a computer program stored therein. The computer program comprises a plurality of codes, the computer program executes a controlling method after being loaded into an electronic apparatus. The controlling method comprises following steps: capturing a real-time image comprising the wearable apparatus worn on a hand of a user; calculating a posture corresponding to the hand based on the real-time image, wherein the posture comprises a reference point located on the hand; in response to determining to activate an input operation based on the reference point and a relative position of a virtual object displayed by the display, selecting a first gesture corresponding to the reference point from a plurality of gestures based on a plurality of inertial measurement parameters received from the wearable apparatus; and generating an input event corresponding to the virtual object based on the first gesture and an input target corresponding to the input operation.

The detailed technology and preferred embodiments implemented for the subject disclosure are described in the following paragraphs accompanying the appended drawings for people skilled in this field to well appreciate the features of the claimed invention.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a control signal generating system according to a first embodiment of the present disclosure.

FIG. 2 is a schematic diagram illustrating a head-mounted display according to a first embodiment of the present disclosure.

FIG. 3 is a flow diagram illustrating the head-mounted display generating a control signal based on a gesture input according to some embodiments of the present disclosure.

FIG. 4 is a flow diagram illustrating generating hand posture based on a real-time image according to some embodiments of the present disclosure.

FIG. 5A is a schematic diagram illustrating the user wearing the wearable apparatus according to some embodiments of the present disclosure.

FIG. 5B is a schematic diagram illustrating a vertical extension area corresponding to a key according to some embodiments of the present disclosure.

FIG. 6 is a schematic diagram illustrating a flick gesture according to some embodiments of the present disclosure.

FIG. 7 is a schematic diagram illustrating the user operating a virtual keyboard according to some embodiments of the present disclosure.

FIG. 8 is a schematic diagram illustrating a control method according to a second embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

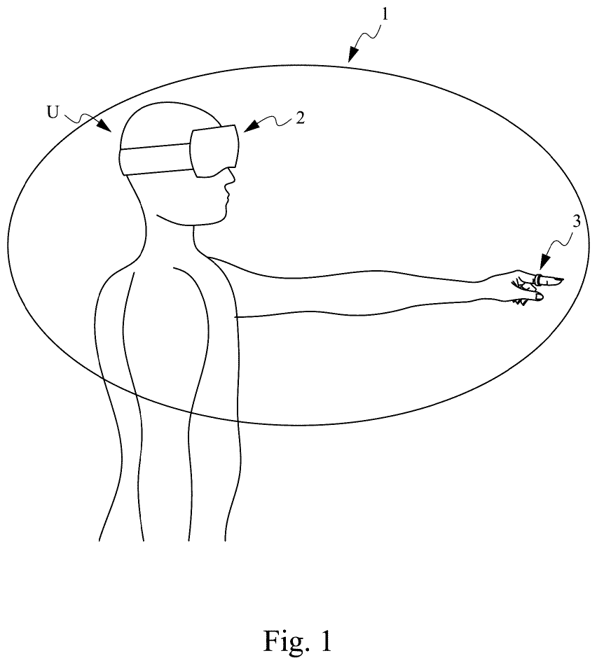

First, the applicable scene of the present embodiment will be described, and a schematic diagram of which is depicted in FIG. 1. As shown in FIG. 1, in the application environment of the present disclosure, a user U may use a head-mounted display 2, and the user U may wear a wearable device 3 on a body part (e.g., the user U wears a smart ring on the index finger of the left hand) to perform control operations (e.g., applications) corresponding to the display screen of the head-mounted display 2.

In the first embodiment of the present disclosure, the control signal generating system 1 comprises a head-mounted display 2 and a wearable device 3, and the head-mounted display 2 is communicatively connected to the wearable device 3. The control signal generating system 1 is configured to generate an input control signal based on an image and inertial measurement parameters of a hand of a user.

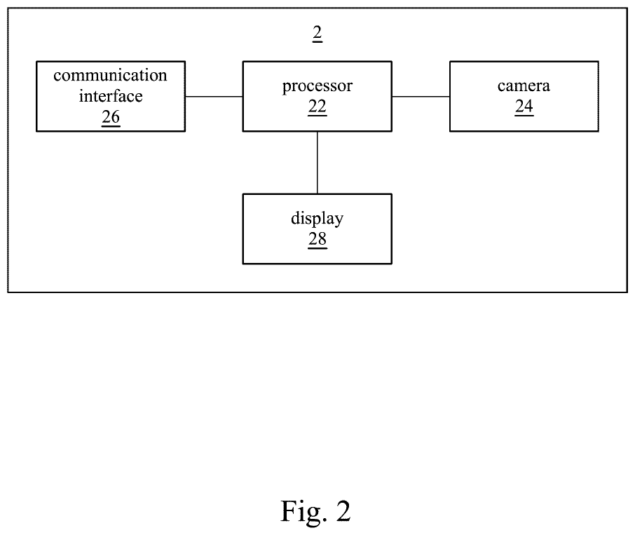

In the present embodiment, a schematic diagram of the structure of the head-mounted display 2 is depicted in FIG. 2. The head-mounted display 2 comprises a processor 22, a camera 24, a communication interface 26, and a display 28. The processor 22 is coupled to the camera 24, the communication interface 26, and the display 28.

In some embodiments, the camera 24 comprises one or more image capture unit (e.g., multiple depth camera lenses) configured to capture a real-time image comprising the wearable apparatus 3 worn on a hand of the user U.

In some embodiments, the camera 24 captures the real-time image corresponding to a field of view (FOV), and the hand of the user U wearing the wearable device 3 is included in the field of view.

The communication interface 26 is communicatively connected to the wearable apparatus 3 and receives inertial measurement parameters corresponding to the hand of the user U from the wearable apparatus 3.

The display 28 is configured to display images to provide the user U an interactive interface. In some embodiments, the display 28 displays virtual objects in a space to provide the user U to watch and interact with the virtual objects.

In some embodiments, the wearable apparatus 3 comprises an inertial measurement unit configured to measure inertial measurement parameters of the hand of the user U wearing the wearable device 3. Specifically, the inertial measurement unit may continuously generate a series of inertial measurement parameters (e.g., a stream of inertial measurement parameters generated at a frequency of 10 times per second), and each of the inertial measurement parameters may comprises an acceleration, an amount of rotation, and an angular acceleration. During operation, the head-mounted display 2 may periodically receive the inertial measurement parameters from the wearable device 3.

It shall be appreciated that the inertial measurement parameters generated by the wearable device 3 may correspond to the hand of the user U. For example, the user U may wear the wearable device 3 on any finger to collect data. For convenience of description, in the present embodiment, the user U may be described wearing the wearable device 3 on the index finger.

In some embodiments, the communication interface 26 is an interface capable of receiving and transmitting data or other interfaces capable of receiving and transmitting data and known to those of ordinary skill in the art. The communication interface can receive data from sources such as external apparatuses, external web pages, external applications, and so on.

In some embodiments, the processor 22 comprises a central processing unit (CPU), a graphics processing unit (GPU), a multi-processor, a distributed processing system, an application specific integrated circuit (ASIC), and/or a suitable processing unit.

It shall be appreciated that FIG. 1 is merely an example for illustration, and the present disclosure does not limit the content of the control signal generating system 1. For example, the present disclosure does not limit the number of wearable devices 3 connected to the head-mounted display 2. The head-mounted display 2 may be connected to a plurality of wearable devices through the network at the same time, depending on the scale and actual requirements of the control signal generating system 1.

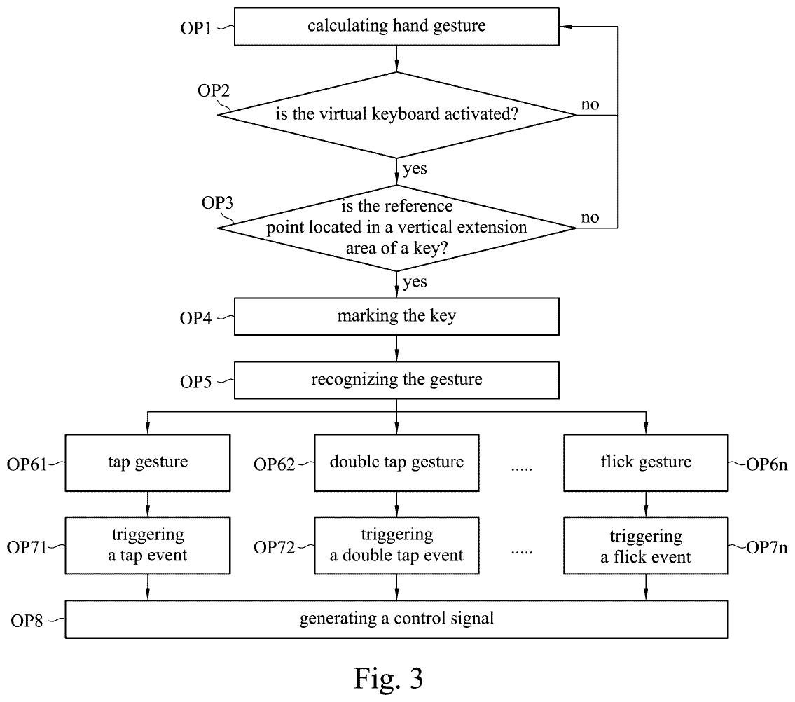

For details on how the head-mounted display 2 generates control signals, please refer to FIG. 3.

After the camera 24 obtains the real-time image, the processor 22 executes an operation OP1 and calculates a posture of the hand of the user U based on the real-time image. Specifically, the processor 22 calculates a posture corresponding to the hand based on the real-time image, wherein the posture comprises a reference point located on the hand.

In some embodiments, the operation of the processor 22 calculating the posture comprises: the processor 22 calculating a plurality of keypoints of the hand in the real-time image; and the processor 22 generating the posture of the hand in a three-dimensional space based on the keypoints and a depth information in the real-time image.

In some embodiments, the operation of the processor 22 selecting one of the keypoints as the reference point.

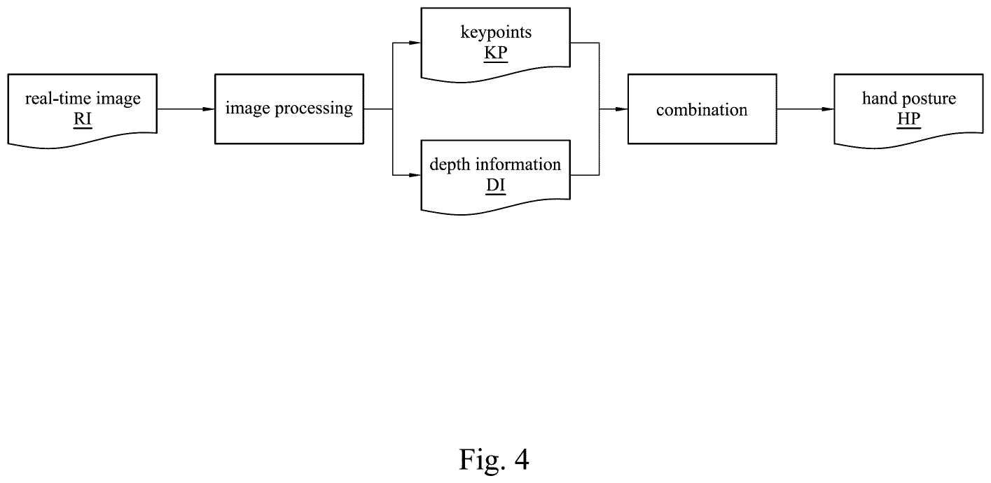

For details about calculating the hand posture, please refer to FIG. 4. As shown in the figure, after obtaining the real-time image RI captured by the camera 24, the processor 22 then performs image recognition on the real-time image RI to generate key points KP and depth information DI of the hand of the user U.

For example, the processor 22 recognizes multiple joint positions of the hand in the real-time image RI as the keypoints, e.g., the positions of the palm, fingers, knuckles, finger bases. On the other hand, when the camera 24 comprises a depth camera lens, the real-time image RI captured accordingly comprises depth information DI corresponding to each of the pixels. Furthermore, the processor 22 combines multiple keypoints calculated and the depth information DI in the real-time image RI to confirm the positions of the keypoints in a three-dimensional space. Accordingly, the processor 22 is able to obtain a hand posture HP of the user U in the three-dimensional space.

It is noted that, the reference point is selected from the key points KP by the head-mounted display 2 and also a datum point for confirming the target the user U is operating with. The function of the reference point is similar with a cursor of a personal computer or a tap position on a touch screen by the user.

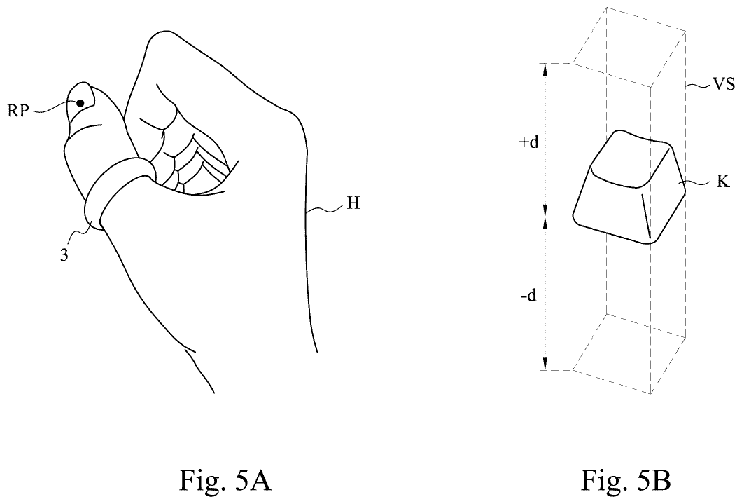

Please refer to FIG. 5A, in some embodiments, the head-mounted display 2 selects a index finger of a hand H of the user U wearing the wearable apparatus 3 as the reference point. As shown in the figure, the user U wears the wearable apparatus 3 on a thumb. Accordingly, the user U is able to operate the head-mounted display 2 by a posture of virtually holding the palm and tapping the side of the index finger by the thumb. This posture is similar to the operating posture of holding a smart phone by a palm and four fingers and tapping the screen of the phone by a thumb while operating the smart phone. Accordingly, the head-mounted display 2 is able to provide the user to input information in a familiar way. Additionally, since the thumb will face towards the head of the user U without being obscured while the hand of the user U making the gesture shown in FIG. 5A, the head-mounted display 2 is able to capture the real-time image of the reference point more easily.

In some embodiments, the virtual object is a virtual keyboard, the virtual keyboard comprises multiple keys, and the input target corresponds to one of the keys.

Please return to FIG. 3, after calculating the posture of the user U, the head-mounted display 2 executes an operation OP2 and determines whether the virtual keyboard is activated. If the virtual keyboard is activated, it represents that the head-mounted display 2 is in an input mode and further determines the input information based on the posture and gesture of the user U. On the contrary, if the virtual keyboard is not activated, it represents that the head-mounted display 2 is not in the input mode and returns to the operation OP1 to continue to determine the posture of the user U.

It is noted that, in the present embodiment, the operation OP2 takes the determination of whether the virtual keyboard is activated as an example. In other embodiments, the head-mounted display 2 may skip the operation or determine if it is needed to determine the information inputted by the user U through other operations, e.g., determining whether to activate a menu.

If it is determined that the virtual keyboard is activated, the head-mounted display 2 determines the function the user U wants to operate or the information inputted by the user U based on the hand position of the user U. Specifically, the processor 22 determines whether to activate an input operation based on the reference point and a relative position of a virtual object displayed by the display.

In the embodiment shown in FIG. 3, the head-mounted display 2 executes an operation OP3 first, determining whether the reference point RP is located in a vertical extension area of the virtual keyboard.

Specifically, the processor 22 determines whether the relative position of the reference point is located in a vertical extension area of the virtual object, wherein the vertical extension area is constituted by vertically extending a distance from a plurality of subobjects in the virtual object; and in response to the relative position of the reference point is located in the vertical extension area, the processor 22 determines to activate the input operation.

Please refer to FIG. 5B, which is a schematic diagram illustrating a vertical extension area VS corresponding to a key K according to some embodiments of the present disclosure. As shown in the figure, an area of distances d above and below the key K of the virtual keyboard constitutes the vertical extension area VS. Accordingly, the processor 22 determines whether the reference point RP on the hand of the user U is located in multiple vertical extension areas constituted by multiple keys on the virtual keyboard. If so, the processor 22 then determines that the user U may interact with the virtual keyboard, thus activating an input operation.

Additionally, the head-mounted display 2 also selects the input target of the user U based on the position of the reference point. For example, when the reference point RP is located in the vertical extension area VS of the key K, the processor 22 determines that the user U may interact with the key K, thus setting the key K as the input target.

Specifically, when the first gesture is a tap gesture, the input target is generated through the following operations: the processor 22 calculating a projection point of the reference point on a virtual plane corresponding to the virtual object; and the processor 22 selecting a first subobject from a plurality of subobjects corresponding to the virtual object as the input target based on the projection point.

For example, when the virtual object is a virtual keyboard, the processor 22 calculates a projected point position of the thumb of the user U (i.e., the reference point RP) on the plane constituted by the virtual keyboard and selects a corresponding key according to the projected point position located on the virtual keyboard.

It is noted that, for clarity, the virtual keyboard is taken as an example of the virtual object in the present disclosure. However, in other embodiments, the head-mounted display 2 may also take other objects as the virtual object (e.g., menu, dashboard).

When the reference point RP is located in the vertical extension area VS, it represents that the corresponding projected point is located on the key K, and the reference point RP is located at a distance of plus or minus d from the key K within the vertical extension area VS. Accordingly, the head-mounted display 2 determines that the user U may select the key K. On the contrary, if the reference point RP is not located in the vertical extension area VS, the head-mounted display 2 determines that the user U may select another key or does not interact with the virtual keyboard.

It is noted that, the head-mounted display 2 may apply the same method on multiple keys on the virtual keyboard to determine the key the user U may interacting with.

Please return to FIG. 3, if the reference point RP is not located in the vertical extension area VS, the head-mounted display 2 returns to the operation OP1 to continue to determine the posture of the user U.

On the other hand, if the reference point RP is located in the vertical extension area VS, the head-mounted display 2 executes an operation OP4 to marking a key corresponding to the reference point RP. Specifically, in response to determining to activate the input operation, the processor 22 marks one of the subobjects closest to the reference point.

In the embodiment shown in FIG. 5B, the processor 22 may mark the key K by making the key K glowing or coloring the key K in another color to provide the user U to confirm the key corresponding to the current hand posture. It is noted that, in some embodiments, the operation OP4 can be skipped optionally.

After activating the input operation, the head-mounted display 2 executes an operation OP5 to recognize the gesture of the user U based on the inertial measurement parameters transmitted by the wearable apparatus 3. Specifically, in response to determining to activate the input operation, the processor 22 selects a first gesture corresponding to the reference point from a plurality of gestures based on a plurality of inertial measurement parameters received from the wearable apparatus.

In some embodiments, the processor 22 inputs the inertial measurement

parameters into a classification model to select the first gesture from the gestures. Specifically, the classification model is a trained machine learning model configured to classify the hand gesture of the user U into one of multiple known gestures based on the inertial measurement parameters. Furthermore, the input event comprises a tap event, a double event, and a flick event.

In some embodiments, the head-mounted display 2 captures the inertial measurement parameters generated in a time interval (e.g., 50 milliseconds) after activating the input operation to determine the gesture of the user U. Specifically, in response to determining to activate the input operation, the processor 22 receives the inertial measurement parameters captured in a time interval after activating the input operation from the wearable apparatus 3.

After recognizing the gesture of the user U, the head-mounted display 2 triggers the corresponding event based on the gesture and the key the user U interacting with. As shown in FIG. 3, the processor 22 may recognize n gestures such as the tap gesture, the double gesture, and the flick gesture (corresponding to operation OP61-OP6n respectively), wherein n is a positive integer.

Furthermore, the head-mounted display 2 triggers the event corresponding to the gesture of the user U and generates the corresponding control signal. Specifically, the processor 22 generate an input event corresponding to the virtual object based on the first gesture and an input target corresponding to the input operation.

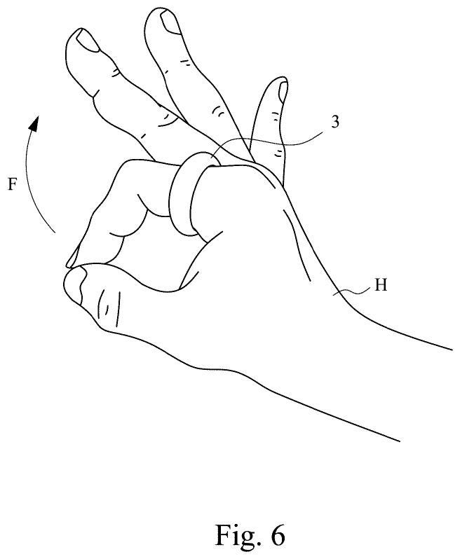

Through the aforementioned operation, the user U may trigger different functions by different hand movements. Take FIG. 5A as an example, the user U may trigger the tap event through the gesture of tapping the side of the index finger once by the thumb (i.e., the tap gesture) and trigger the double tap event through the gesture of tapping the side of the index finger twice by the thumb (i.e., the double tap gesture). Take FIG. 6 as an example, the user U may also trigger the flick event through the gesture of pinching the index finger and the thumb and then flicking the thumb in a direction F (i.e., the flick gesture).

In an embodiment, when the user U making the tap gesture is recognized (i.e., the operation OP61), the head-mounted display 2 executes an operation OP71 to trigger the tap event.

The processor 22 first confirms the subobject (e.g., the key K) the user U interacting with through the aforementioned operation of selecting the input target and then executes an operation OP8 to generate a control signal of tapping the key K (e.g., typing input).

In another example, at least one edge position of the virtual object comprises a virtual label, and when the first gesture is a double tap gesture, the operation of generating the input event corresponding to the virtual object further comprises: the processor 22 determining whether the reference point is located on a space position of the virtual label; and in response to the reference point is located on the space position of the virtual label, the processor 22 generating the input event corresponding to the virtual object based on a displacement distance of the double tap gesture.

In some embodiments, the input event comprises a zooming operation and a virtual object dragging operation.

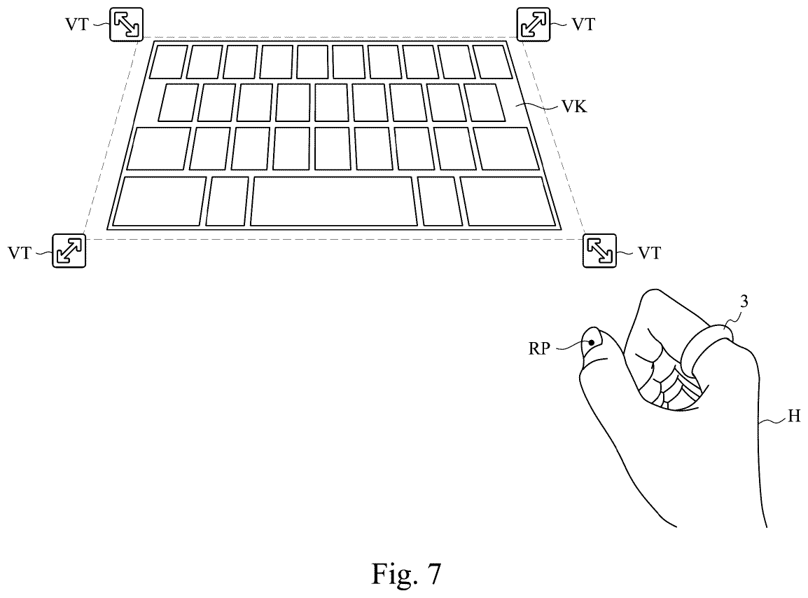

For example, please refer to FIG. 7, when the user U making the double tap gesture is recognized (i.e., the operation OP62), and the user U is determined to interact with a virtual tag VT of the virtual keyboard (i.e., the reference point RP is located in the vertical extension area of the virtual tag VT), the head-mounted display 2 executes an operation OP71 to trigger the double tap event and further executes the operation OP8 to generate a control signal of double tapping the virtual tag VT. Accordingly, the head-mounted display 2 adjusts the size and/or the position of the virtual keyboard VK along with the moving position of the hand of the user U.

In the other example, when the first gesture is a flick gesture, the operation of generating the input event corresponding to the virtual object further comprises: the processor 22 moving the virtual object to an initial position; and the processor 22 adjusting a size of the virtual object.

For example, when the user U making the flick gesture is recognized (i.e., the operation OP6n), the head-mounted display 2 executes an operation OP7n to trigger the flick event and further executes the operation OP8 to generate a control signal of flick gesture (e.g., resetting the virtual keyboard VK). Accordingly, the head-mounted display 2 resets the virtual keyboard VK to a preset size and/or a preset position.

It is noted that, the types, the number, or the corresponding function of the gestures in the present embodiment are only for ease of illustrating, and the head-mounted display 2 may set one or more gesture corresponding to one or more function in practical application. Additionally, when the same gesture corresponding to different interacting areas (e.g., different keys on the virtual keyboard), the head-mounted display 2 will also trigger different events to generate different control signals (e.g., input different characters while typing).

In summary, the control signal generating system 1 in the present disclosure determines the hand posture of the user based on the real-time image captured by the head-mounted display 2 and determines the hand gesture of the user based on the inertial measurement parameters obtained by the wearable apparatus 3. The control signal generating system 1 is able to solve the problem of low accuracy of image recognition for subtle hand movements and the difficulty of locating the hand in three-dimensional space by only the inertial measurement parameters. By combining two technologies, the control signal generating system 1 is able to determine the information inputted by the user more precisely while providing a friendlier and handier human-computer interaction experience.

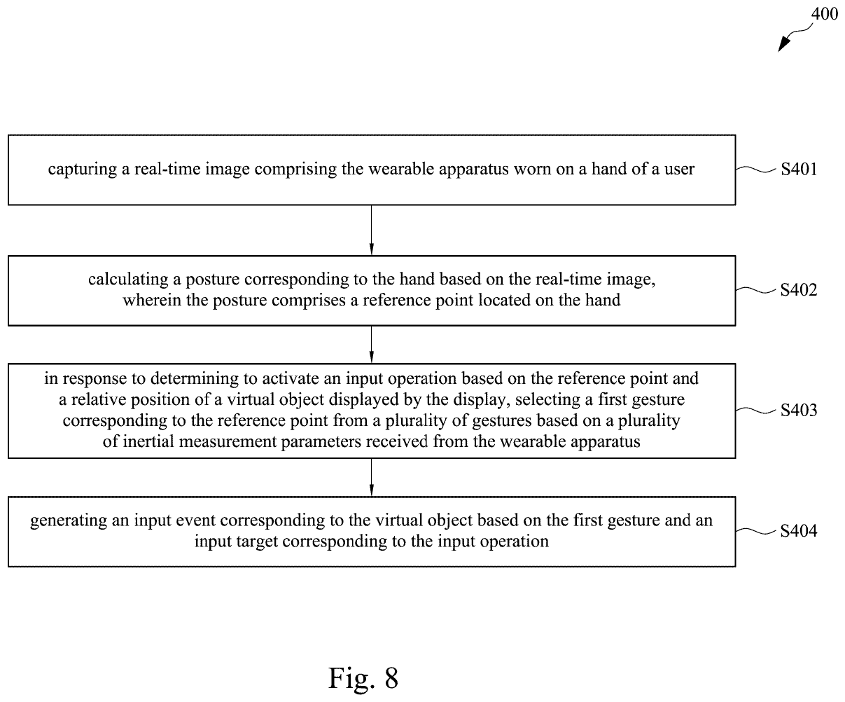

Please refer to FIG. 8, which is a schematic diagram illustrating a control method 400 according to a second embodiment of the present disclosure. The control method 400 comprises steps S401-S405. The control method 400 is configured to generate an input control signal based on an image and inertial measurement parameters of a hand of a user. The control method 400 can be executed by an electronic apparatus (e.g., the head-mounted display 2 in the first embodiment), wherein the electronic apparatus is communicatively connected to a wearable apparatus.

First, in the step S401, the electronic apparatus captures a real-time image comprising the wearable apparatus worn on a hand of a user.

Next, in the step S402, the electronic apparatus calculates a posture corresponding to the hand based on the real-time image, wherein the posture comprises a reference point located on the hand.

Next, in the step S403, in response to determining to activate an input operation based on the reference point and a relative position of a virtual object displayed by the display, the electronic apparatus selects a first gesture corresponding to the reference point from a plurality of gestures based on a plurality of inertial measurement parameters received from the wearable apparatus.

Finally, in the step S404, the electronic apparatus generates an input event corresponding to the virtual object based on the first gesture and an input target corresponding to the input operation.

In some embodiments, the step S402 further comprises the electronic apparatus calculating a plurality of keypoints of the hand in the real-time image; and the electronic apparatus generating the posture of the hand in a three-dimensional space based on the keypoints and a depth information in the real-time image.

In some embodiments, the step S402 further comprises the electronic apparatus selecting one of the keypoints as the reference point.

In some embodiments, the control method 400 further comprises the electronic apparatus determining whether the relative position of the reference point is located in a vertical extension area of the virtual object, wherein the vertical extension area is constituted by vertically extending a distance from a plurality of subobjects in the virtual object; and in response to the relative position of the reference point is located in the vertical extension area, the electronic apparatus determining to activate the input operation.

In some embodiments, when the first gesture is a tap gesture, the input target is generated through the following steps: calculating a projection point of the reference point on a virtual plane corresponding to the virtual object; and selecting a first subobject from a plurality of subobjects corresponding to the virtual object as the input target based on the projection point.

In some embodiments, at least one edge position of the virtual object comprises a virtual label, and when the first gesture is a double tap gesture, the step S405 further comprises: the electronic apparatus determining whether the reference point is located on a space position of the virtual label; and in response to the reference point is located on the space position of the virtual label, the electronic apparatus generating the input event corresponding to the virtual object based on a displacement distance of the double tap gesture.

In some embodiments, the input event comprises a zooming operation and a virtual object dragging operation.

In some embodiments, when the first gesture is a flick gesture, the step S405 further comprises: the electronic apparatus moving the virtual object to an initial position; and the electronic apparatus adjusting a size of the virtual object.

In some embodiments, the virtual object comprises a plurality of subobjects, and the control method 400 further comprises: in response to determining to activate the input operation, the electronic apparatus marking one of the subobjects closest to the reference point.

In some embodiments, the control method 400 further comprises: in response to determining to activate the input operation, the electronic apparatus receiving the inertial measurement parameters captured in a time interval after activating the input operation from the wearable apparatus.

In some embodiments, the step S405 further comprises: the electronic apparatus inputs the inertial measurement parameters into a classify model to select the first gesture from the gestures.

In some embodiments, the input event comprises a tap event, a double event, and a flick event.

In summary, the control method 400 in the present disclosure determines the hand posture of the user based on the real-time image captured by the electronic apparatus and determines the hand gesture of the user based on the inertial measurement parameters obtained by the wearable apparatus. The control method 400 is able to solve the problem of low accuracy of image recognition for subtle hand movements and the difficulty of locating the hand in three-dimensional space by only the inertial measurement parameters. By combining two technologies, the control method 400 is able to determine the information inputted by the user more precisely while providing a friendlier and handier human-computer interaction experience.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A head-mounted display, comprising:
a display;
a communication interface, communicatively connected to a wearable apparatus;
a camera, configured to capture a real-time image comprising the wearable apparatus worn on a hand of a user; and
a processor, coupled to the display, the communication interface, and the camera, configured to:
calculate a posture corresponding to the hand based on the real-time image, wherein the posture comprises a reference point located on the hand;
in response to determining to activate an input operation based on the reference point and a relative position of a virtual object displayed by the display, receive a plurality of inertial measurement parameters captured in a time interval after activating the input operation from the wearable apparatus, and select a first gesture corresponding to the reference point from a plurality of gestures based on the plurality of inertial measurement parameters received from the wearable apparatus; and
generate an input event corresponding to the virtual object based on the first gesture and an input target corresponding to the input operation.

2. The head-mounted display of claim 1, wherein the operation of calculating the posture comprises:
calculating a plurality of keypoints of the hand in the real-time image; and
generating the posture of the hand in a three-dimensional space based on the keypoints and a depth information in the real-time image.

3. The head-mounted display of claim 2, wherein the operation of calculating the posture further comprises:
selecting one of the keypoints as the reference point.

4. The head-mounted display of claim 1, wherein the processor is further configured to:
determine whether the relative position of the reference point is located in a vertical extension area of the virtual object, wherein the vertical extension area is constituted by vertically extending a distance from a plurality of subobjects in the virtual object; and
in response to the relative position of the reference point is located in the vertical extension area, determine to activate the input operation.

5. The head-mounted display of claim 1, wherein when the first gesture is a tap gesture, the input target is generated through the following operations:
calculating a projection point of the reference point on a virtual plane corresponding to the virtual object; and
selecting a first subobject from a plurality of subobjects corresponding to the virtual object as the input target based on the projection point.

6. The head-mounted display of claim 1, wherein at least one edge position of the virtual object comprises a virtual label, and when the first gesture is a double tap gesture, the operation of generating the input event corresponding to the virtual object further comprises:
determining whether the reference point is located on a space position of the virtual label; and
in response to the reference point is located on the space position of the virtual label, generating the input event corresponding to the virtual object based on a displacement distance of the double tap gesture.

7. The head-mounted display of claim 6, wherein the input event comprises a zooming operation and a virtual object dragging operation.

8. The head-mounted display of claim 1, wherein when the first gesture is a flick gesture, the operation of generating the input event corresponding to the virtual object further comprises:
moving the virtual object to an initial position; and
adjusting a size of the virtual object.

9. The head-mounted display of claim 1, wherein the virtual object comprises a plurality of subobjects, and the processor is further configured to:
in response to determining to activate the input operation, mark one of the subobjects closest to the reference point.

10. (canceled)

11. A control method, being adapted for use in an electronic apparatus, wherein the electronic apparatus is communicatively connected to a wearable apparatus, and the control method comprises the following steps:
capturing a real-time image comprising the wearable apparatus worn on a hand of a user;
calculating a posture corresponding to the hand based on the real-time image, wherein the posture comprises a reference point located on the hand;
in response to determining to activate an input operation based on the reference point and a relative position of a virtual object displayed by the display, receiving a plurality of inertial measurement parameters captured in a time interval after activating the input operation from the wearable apparatus, and selecting a first gesture corresponding to the reference point from a plurality of gestures based on the plurality of inertial measurement parameters received from the wearable apparatus; and
generating an input event corresponding to the virtual object based on the first gesture and an input target corresponding to the input operation.

12. The control method of claim 11, wherein the step of calculating the posture comprises:
calculating a plurality of keypoints of the hand in the real-time image; and
generating the posture of the hand in a three-dimensional space based on the keypoints and a depth information in the real-time image.

13. The control method of claim 12, wherein the step of calculating the posture further comprises:
selecting one of the keypoints as the reference point.

14. The control method of claim 11, further comprises:
determining whether the relative position of the reference point is located in a vertical extension area of the virtual object, wherein the vertical extension area is constituted by vertically extending a distance from a plurality of subobjects in the virtual object; and
in response to the relative position of the reference point is located in the vertical extension area, determining to activate the input operation.

15. The control method of claim 11, wherein when the first gesture is a tap gesture, the input target is generated through the following steps:
calculating a projection point of the reference point on a virtual plane corresponding to the virtual object; and
selecting a first subobject from a plurality of subobjects corresponding to the virtual object as the input target based on the projection point.

16. The control method of claim 11, wherein at least one edge position of the virtual object comprises a virtual label, and when the first gesture is a double tap gesture, the step of generating the input event corresponding to the virtual object further comprises:
determining whether the reference point is located on a space position of the virtual label; and
in response to the reference point is located on the space position of the virtual label, generating the input event corresponding to the virtual object based on a displacement distance of the double tap gesture.

17. The control method of claim 16, wherein the input event comprises a zooming operation and a virtual object dragging operation.

18. The control method of claim 11, wherein when the first gesture is a flick gesture, the step of generating the input event corresponding to the virtual object further comprises:
moving the virtual object to an initial position; and
adjusting a size of the virtual object.

19. The control method of claim 11, wherein the virtual object comprises a plurality of subobjects, and the control method further comprises:
in response to determining to activate the input operation, marking one of the subobjects closest to the reference point.

20. A non-transitory computer readable storage medium, having a computer program stored therein, wherein the computer program comprises a plurality of codes, the computer program executes a control method after being loaded into an electronic apparatus, the controlling method comprises:
capturing a real-time image comprising a wearable apparatus worn on a hand of a user;
calculating a posture corresponding to the hand based on the real-time image, wherein the posture comprises a reference point located on the hand;
in response to determining to activate an input operation based on the reference point and a relative position of a virtual object displayed by the display, receiving a plurality of inertial measurement parameters captured in a time interval after activating the input operation from the wearable apparatus, and selecting a first gesture corresponding to the reference point from a plurality of gestures based on the plurality of inertial measurement parameters received from the wearable apparatus; and
generating an input event corresponding to the virtual object based on the first gesture and an input target corresponding to the input operation.
